(19) United States
(12) Patent Application Publication
(10) Pub. No.: US 2023/0274454 A1
(43) Pub. Date: Aug. 31, 2023

(54) CORRECTION MAPPING

(71) Applicant: Hewlett-Packard Development Company, L.P., Spring, TX (US)

(72) Inventors: Stephen Bernard Pollard, Bristol (GB); Fraser John Dickin, Bristol (GB); Guy de Warrenne Bruce Adams, Bristol (GB); Faisal Azhar, Bristol (GB)

(73) Assignee: Hewlett-Packard Development Company, L.P., Spring, TX (US)

(21) Appl. No.: 18/019,697

(22) PCT Filed: Aug. 3, 2020
(86) PCT No.: PCT/US2020/044746

§ 371 Date: Feb. 3, 2023

(51) Int. Cl. G06T 7/593; G01B 11/25

(52) U.S. Cl. CPC G06T 7/593; G01B 11/2504; G01B 11/2522; G06T 2207/10028

(57) ABSTRACT

Disclosed herein are methods, apparatus, and computer program code for determining a correcting mapping, comprising: locating a test object having a known linear dimension at a plurality of positions within a volume; at each of the plurality of positions, capturing a three-dimensional scan of the test object using a three-dimensional imaging device; and determining a difference between the known linear dimension and the linear dimension as obtained from the captured scan; and determining a correction mapping for the volume based on the determined differences, the correction mapping indicating variation from an expected location of the location as captured by the imaging device.

Three dimensional (3D) printers are revolutionising additive manufacturing. A scan, or image, of a printed object may be obtained using a scanner. The image obtained from the object may not exactly match the actual object; for example the field of view may be distorted in the image.

Example implementations will now be described with reference to the accompanying drawings in which:

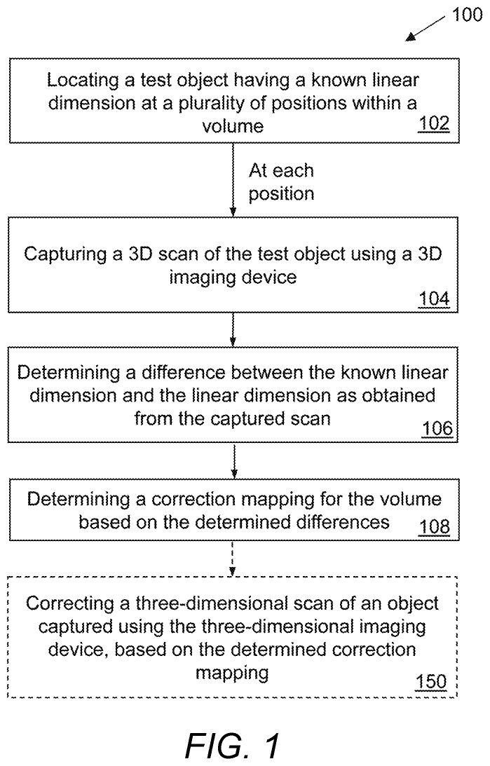

FIG. 1 shows a method of obtaining a correction mapping, according to example implementations;

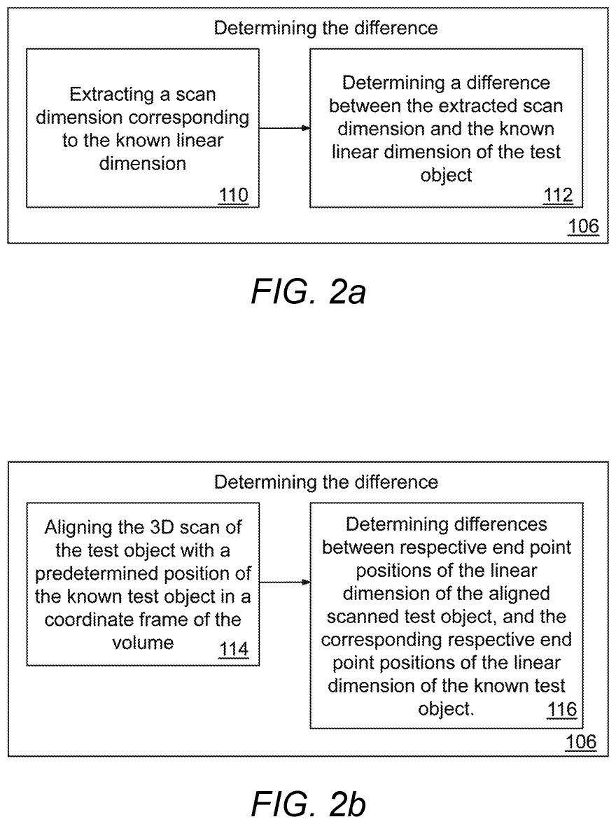

FIGS. 2a-2b illustrate methods of determining a difference between a known and a captured linear dimension, according to example implementations;

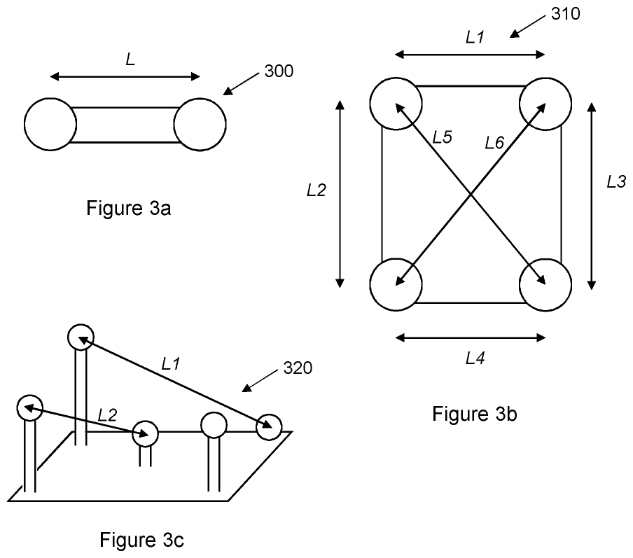

FIGS. 3a-3e schematically show test objects, according to example implementations;

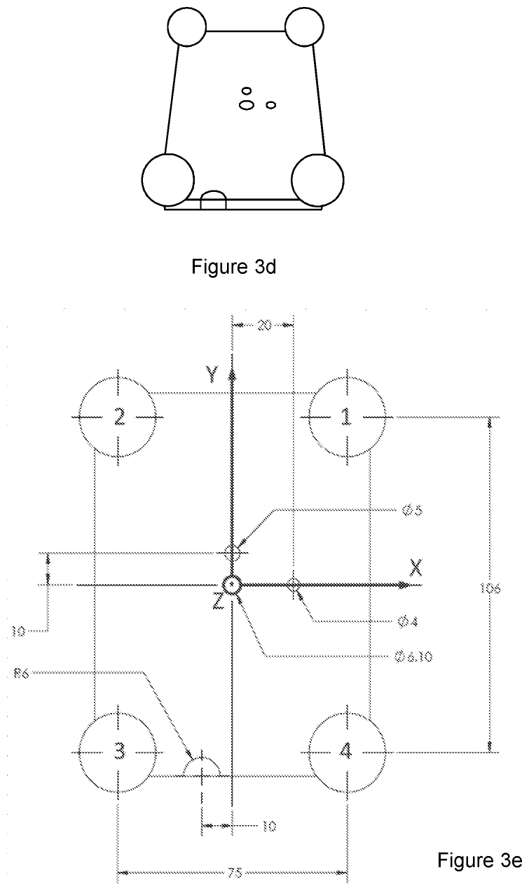

FIG. 4 shows an example workflow to obtain a correction mapping using non-linear optimisation, according to example implementations;

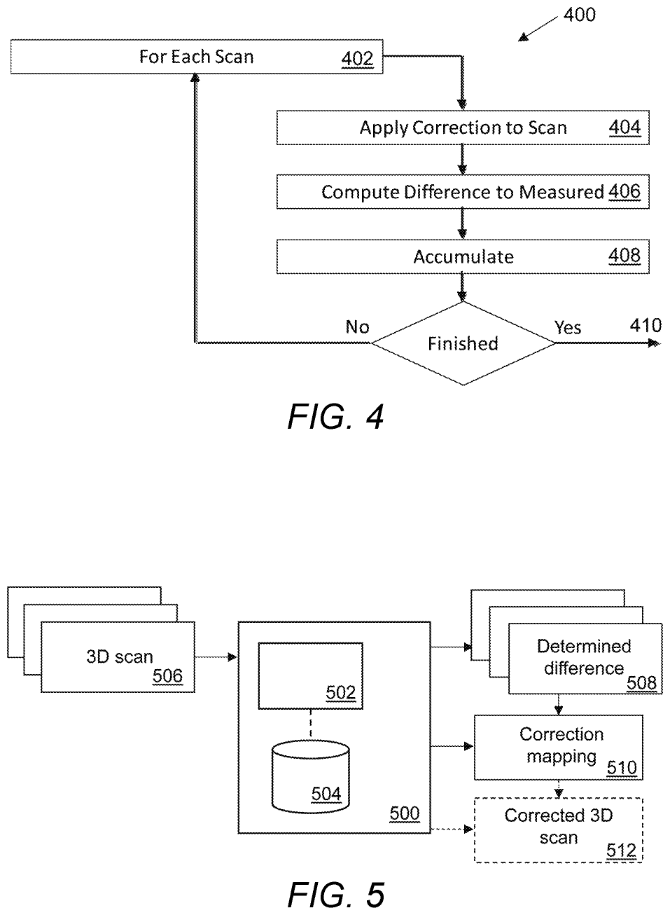

FIG. 5 shown an example apparatus according to example implementations;

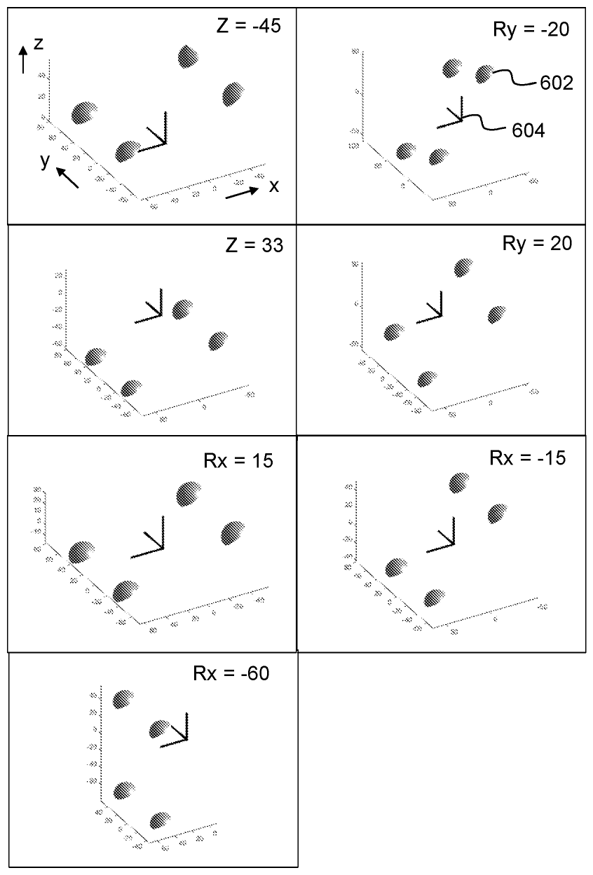

FIG. 6 illustrates an example of positioning a test object, according to example implementations; and

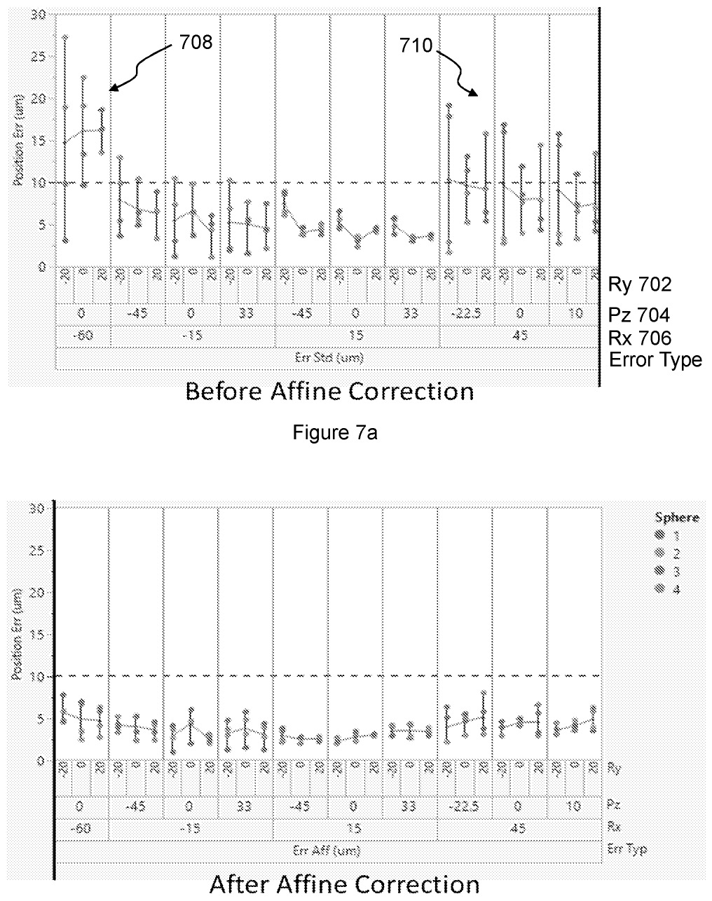

FIGS. 7a-7b shows correction results from a test method according to example implementations.

An image of three-dimensional (3D) space, such as a 3D scan of an object in a volume, may be distorted compared with the true/physical spatial occupancy of the object. Such distortions may arise, for example, due to the combination of different electro-optical components used to obtain the 3D image, and/or from image reconstruction algorithms used as part of the scanning process.

A 3D scanner such as a 3D structured light scanner may be marketed on its ability to resolve detail in a defined field of volume, for example at an accuracy of up to 35 μm in a volume of 71×98 mm (XY near) to 100×154 mm (XY far) over a distance (Z) of 110 mm. However, the claimed accuracy may not actually be achievable over the whole of the scanning volume.

Corrections to an 3D image may be understood by using an apparatus with functionality such as that provided by a CMM (co-ordinate measurement machine) to accurately determine how a 3D structured light scanner observes objects throughout its defined scanning volume. In addition to characterizing the scanner, the positional differences between CMM and 3D scanner data may also be used to create a volumetric correction map. Such a map can be applied to the output from the scanning system in order to reduce or eliminate systemic distortions and thereby improve the overall accuracy of the scanner. However, such apparatuses can be an expensive and cumbersome piece of laboratory equipment, which may take a long time to operate and so cannot be deployed in practice as a practical workable tool for scan correction, and for which the scanner volume is limited to the working volume of the CMM.

The distortion of space perceived by a 3D scanner may, in some cases, be suitably characterized as a projective or affine correction. Such a correction may be expressed as a homogeneous correction matrix. If recovered, the correction matrix may be used to create a correction map to eliminate or reduce distortions.

Examples disclosed herein may be used to accurately characterize the distortion of the field of view observed by a 3D scanner, for example based on repeated 3D scans of a known measurement object/test object at different locations/poses in the field of view or scanner volume of the 3D scanner.

As described herein, a scheme such as a non-linear optimisation scheme, or a neural network, may be used to update the parameters of a correction mapping in order to minimize the combined measurement error of the scanned artifacts/test objects. This may provide a practical solution in the field to improve scanner accuracy. The artifact may be scanned by a user in either a manual or automated way in multiple locations and orientations, provided they cover the working volume of a 3D scanner which is to be characterized. Approaches disclosed herein may be easily scalable as different size of measured artifact/test object can be used for varying the working volume of a 3D scanner.

A precise relationship between the different positions, and/or a precise positioning tool for positioning the test object in the space, are not required, because the dimensions of the well-characterised test object are compared with the measured equivalent dimensions, rather than comparing absolute coordinates of individual points in the volume. Thus, practical solutions allowing for the characterization of the field of view and any distortions of the image space may be achieved using examples disclosed herein, and may be used to correct 3D images to improve scanner output accuracy.

FIG. 1 shows a computer-implemented method 100 of obtaining a correction mapping, according to example implementations. The method 100 comprises locating a test object having a known linear dimension at a plurality of positions within a volume 120. For example, as a first position, the test object may be positioned at a first 3D coordinate and in a first orientation within the volume. One or more further positions may then have the test object positioned at a further 3D coordinate and/or in a further orientation within the volume. To characterize the volume, the test object (more particularly, the end point(s) of the known linear dimension of the test object) may be positioned in the plurality of positions to cover (i.e. fill, or be present in) the volume to be characterized. The volume to be characterized may be substantially the whole available volume in some examples, or may be a partial portion of the whole available volume (e.g. a central portion, a corner portion, a portion of the volume furthest from the scanning device) in some examples.

At each of the plurality of positions, a three-dimensional scan of the test object is captured using a three-dimensional imaging device 104. The 3D imaging device may be any suitable imaging device to capture the 3D object in space. For example, such a device may use one or more cameras and a form of projector. A projector may project known random patterns, structured patterns, phase shifted patterns or be a laser line that is swept over a test object. Another example is of a traditional passive stereo imaging device which uses two or more cameras and no projector, and correspondences between the images are identified. These devices may all use the same sort of image calibration and correction mappings disclosed herein may be used to correct deficiencies in the 3D images obtained using these methods. As another example, there are forms of 3D scanners which make use of “time of flight” in some way, for example using a pulsed or sinusoidal modulated light pattern and sensing the phase of the returning signal to give a depth map, following processing to, for example, integrate the received signal over time to amplify subtle phase shifts at each pixel location. Again, correction mappings disclosed herein may be used to correct deficiencies in the 3D images obtained using these methods. Thus 3D imaging devices may, or may not, use multiple cameras and a projector, to produce 3D scans which may be improved by distortion correction as disclosed herein.

The method determines a difference between the known linear dimension of the test object and the linear dimension as obtained from the captured scan 106. For example, the test object may have a linear dimension, such as a length between two known end points, of an accurately known size (e.g. 100 mm±2 μm). The dimension as obtained from the 3D scan may be measured at 99 mm, for example. Thus there is a difference of 1 mm which may be corrected for in the 3D image of the test object.

A correction mapping for the 3D volume is determined based on the determined differences 108. The correction mapping indicates variation from an expected location of the location as captured by the imaging device. The correction mapping may be applied to a 3D image of the test object, and may be applied to 3D images of a subsequently imaged object to obtain a more accurate 3D scan of the imaged object.

In some examples, the method comprises correcting a three-dimensional scan of an object captured using the three-dimensional imaging device 150, wherein the correction is based on the determined correction mapping. That is, the output of the 3D scanner/imaging device may be corrected using the obtained correction mapping to reduce or remove distortions in the captured 3D image and provide a scan with improved accuracy compared with a non-corrected scan. Thus, the correction mapping is not necessarily used to calibrate the 3D scanner, because the 3D scanner may already have been calibrated and have a set of calibration parameters in use (although this may be possible). Rather, the correction mapping is used to adjust the resulting 3D image captured by the 3D scanner (e.g. each datapoint in the 3D image may be modified by the correction mapping) to account for distortions in space captured in the 3D image. In some examples, the correction mapping may be used to update the pre-existing calibration parameters such that the device can directly produce a corrected 3D image, and it is not necessary to apply the correction mapping separately.

FIG. 2a illustrates a method 106 of determining a difference between a known and a captured linear dimension, according to example implementations. Determining the difference between the known linear dimension and the linear dimension as obtained from the captured scan may comprise extracting, from the three-dimensional scan, a scan dimension corresponding to the known linear dimension of the test object 110; and determining a difference between the extracted scan dimension and the known linear dimension of the test object 112. This may be considered to be a comparison between the known linear dimension of the test object, and the equivalent linear dimension obtained from the 3D scan of the test object positioned at a particular position/pose in the volume. Different poses/positions of the test object may be translated, and/or rotated, compared with each other. That is, one position of the test object may differ from a further position of the test object by a translation, and/or a rotation, of the test object in the volume. FIG. 2b illustrates a method 106 of determining a difference between a known and a captured linear dimension, according to example implementations. Determining the difference between the known linear dimension and the linear dimension as obtained from the captured scan may comprise aligning the three-dimensional scan of the test object with a predetermined position of the known test object in a coordinate frame of the volume 114; and determining differences between respective end point positions of the linear dimension of the aligned scanned test object, and the corresponding respective end point positions of the linear dimension of the known test object 116. This may be considered to be a comparison between the location of an end point of the known linear dimension of the test object at a particular position in the volume, and the equivalent position of the end point of the linear dimension after performing a spatial transformation of the 3D scan from an imaged position to an aligned position, wherein the aligned position is a “best fit” position of the transformed scan to match the particular position in the volume of the test object. This may also be termed the Euclidean distance between the position of a point of the test object obtained from the 3D scan, and a well-known/accurately characterized position of the same point of the test object, when the well-known position and the position as obtained from the 3D scan of the test object are aligned in a common coordinate frame.

In order to do this, a transformation that best aligns the scan data position and theoretical position data may be determined. A transformation (e.g. a rotation matrix and a translation vector) may be found which brings the scan data into a best correspondence with the theoretical data. This may be expressed as:

$$c = Rs + t$$

$$[ \begin{matrix}{c}_{x} \\ {c}_{y} \\ {c}_{z}\end{matrix} ] = [ \begin{matrix}r 1 & r 2 & r 3 \\ r 4 & r 5 & r 6 \\ r 7 & r 8 & r 9\end{matrix} ] [ \begin{matrix}{s}_{x} \\ {s}_{y} \\ {s}_{z}\end{matrix} ] + [ \begin{matrix}{t}_{x} \\ {t}_{y} \\ {t}_{z}\end{matrix} ]$$

where R is constrained to be a rigid rotation matrix (orthonormal unit vectors); t is a translation vector, c is the “known” theoretical position of a point of the test object, and s is the position of the point of the test object obtained from the 3D scan.

Both the methods of determining a difference between a known and a captured linear dimension obtained from the 3D scan of the test object shown in FIGS. 2a and 2b may comprise determining positions, in the coordinate frame of the volume, of end points of the known linear dimension of the theoretical test object; and determining positions, in the coordinate frame of the volume, of end points of the known linear dimension of the aligned scanned test object. Doing so allows the known linear dimension of the test object to be compared with the linear dimension of the test object as obtained from the 3D scan of the object.

FIGS. 3a-3e schematically show test objects 300, 310, 320, according to example implementations. FIG. 3a illustrates a test object 300 which is a straight bar with a sphere located at each end of the bar. The known linear dimension is the distance L between the centres of the spheres. The bar may, for example, have a circular, ovoid, rectangular, or other cross section. Spheres may be used at the end points of the bar (or other test object), having their centres as end points of the known linear dimension, because a sphere may be imaged/scanned from any point of view and appear the same i.e. they appear invariant.

FIG. 3b illustrates a plan view of a test object 310 comprising a planar structure providing a plurality of mounting points, with a plurality of spheres each located at respective mounting points. The planar structure may be, for example, a rectangular plate, a plurality of bars e.g. arranged in an “X”/cross pattern, rectangular pattern, or other suitable planar mounting structure. The known linear dimension in this case may be a distance between the centres of two spheres either along one edge of the planar structure L1, L2 L3, L4, or across a diagonal of the planar structure L5, L6. In this example the planar structure has four vertices each having a sphere mounted thereon. In other examples there may be more or fewer vertices than four; not all vertices may have a sphere mounted thereon, and/or there may be spheres mounted on the planar structure but not at a vertex of the structure, provided that a distance between two spheres (i.e. centres of the spheres) is well known/accurately characterised.

FIG. 3c illustrates an oblique schematic view of a test object 320 which is a non-planar structure comprising a plurality of structures oriented out of a plane. This example comprises a planar structure with a plurality of further structures (e.g. rods, bars, posts, mounts, blocks) oriented out of the plane of the planar structure, wherein each of the plurality of further structures has one end located on the planar structure and has a sphere located at the opposite end of the further structure. The plurality of spheres are arranged non-parallel to the plane of the planar structure, and in examples where there are three or more spheres, the plurality of spheres are not arranged in a plane, i.e. they are arranged out of a single plane. That is, the positions of the spheres may be arbitrary with respect to the plane of the planar structure. As in FIG. 3b, the planar structure may be, for example, a rectangular plate, a plurality of bars e.g. arranged in an “X”/cross pattern, or other suitable mounting structure. The known linear dimension in this case may be a distance between the centres of any two spheres—two such distances L1, L2 are illustrated but more/fewer/others may be used in other examples. In this example the planar structure has four rods as further structures, each having a sphere mounted thereon with a fifth sphere mounted with its centre in the plane of the planar structure. In other examples there may be more or fewer further structures.

Using a more complex test object; that is, a test object having more known linear dimensions and/or linear dimensions oriented in different directions for a particular positioning of the test object, may allow for fewer different positions of the test object to be scanned to obtain enough data to allow for correction over the volume to be mapped compared to use of a simpler test object, but constructing and measuring the more complex artefact may be more complicated to do, and to do with high accuracy. Also, imaging the artefact may be more difficult, in particular to obtain images of all the spheres, because of self-obscuration of part of the artefact (sphere) by another part of the artefact (e.g. a rod or plate). Using a less complex test object; that is, a test object having fewer known linear dimensions and/or linear dimensions oriented in one or few directions for a particular positioning of the test object, may use more different positions of the test object to be scanned to obtain enough data to allow for correction over the volume to be mapped compared to using a more complex test object, but simpler algorithms/programming may be used to operate on the 3D scan data to obtain the correction mapping.

The test object may be made of a material having thermal expansion properties providing for dimensional variations of the test object due to thermal changes to be lower than the accuracy with which the linear dimension of the test object can be determined from the three-dimensional scans. That is, a low coefficient of thermal expansion may allow for a lower error in the known linear dimension, because it can be more accurately measured and the linear dimension may be known with a low error over a range of possible temperatures. In some examples, the test object may be at least partially made of Invar, FeNi36 (a nickel iron alloy with a low thermal expansion of about 1.2×10⁻⁶ K⁻¹ between 20° C. and 100° C.). Other low/near zero thermal expansion coefficient materials may also be used, for example some carbon fibre composite materials. In some examples, the mounting bar or mounting plate may be made of a low thermal expansion coefficient material such as Invar, because this is the portion of the test object which determines the known linear dimension. The test object (or at least the portion of the test object defining the linear dimension) may also be made of a material which remains straight/flat to a high accuracy, i.e. it is rigid and not flexible, to reduce errors in the known linear dimension due to deformation of the test object in one position different to the deformation in another position of the test object.

The spheres may be made of the same material as the mounting bar or planar mounting plate, or may be made of a material which, for example, is easily machinable to accurately be formed into a sphere, such as steel (in some examples, painted using a suitable even-thickness paint of a colour which allows for easy/low error/ambiguity 3D scanning of the spheres).

FIG. 3d shows a schematic image of a manufactured test object in the form of a ball-plate artifact/test object as in FIG. 3b. This example comprises an Invar plate with four spheres (25 mm accurately painted high grade steel ball-bearings) at the corners.

FIG. 3e shows a nominal geometry of the ball-plate of FIG. 3d. The four spheres are labelled 1 to 4; the z direction is perpendicular to the plane of the plate, and the x and y directions are in the plane of the plate. The distance between the sphere centres along a short edge of the plate (i.e. between spheres 1 and 2, and between spheres 3 and 4) is 75 mm. The distance between the sphere centres along a long edge of the plate (i.e. between spheres 1 and 4, and between spheres 2 and 3) is 106 mm.

Table 1 below illustrates the known (well-characterised) dimensions of the test object, by indicating the measured coordinates of the centres of the four spheres in the coordinate system of the volume, obtained from five trials/measurement sets obtained from a coordinate measurement machine (CMM) measurements That is, the dimensions of the test object have been accurately determined based on the measured sphere diameters and locations with respect to a Datum (a reference point) determined by the CMM. CMM measurement is a method allowing for a highly accurate measurement of the locations of the spheres to be determined, and thus from there the known linear dimension(s) of the test object can be obtained as the difference between two sphere centres.

TABLE 1

| | | | | Sphere |
|---|---|---|---|---|
| Sphere | x co-ord | y co-ord | z co-ord | diameter |
| number | (mm) | (mm) | (mm) | (mm) |
| | CMM average coordinates (mm) | | | |
| 1 | 37.48389 | 52.98521 | −0.02343 | 25.02541 |
| 2 | −37.4839 | 53.00848 | 0.02341 | 25.03398 |
| 3 | −37.4947 | −53.0502 | −0.02341 | 25.03579 |
| 4 | 37.49465 | −52.9852 | 0.02343 | 25.04407 |
| | CMM Standard deviation co-ords (μm) | | | |
| 1 | 0.099 | 0.233095 | 0.082 | 0.137 |
| 2 | 0.099 | 0.42111 | 0.088 | 0.114 |
| 3 | 0.097 | 0.442844 | 0.088 | 0.152 |
| 4 | 0.097 | 0.233095 | 0.082 | 0.298 |

After determining the difference between the known linear dimension and the linear dimension as obtained from the captured scan, for the plurality of positions of the test object, and in this example for each of the linear dimensions, the differences are used to obtain a correction mapping for the volume. Determining the correction mapping may comprise performing a non-linear optimisation using the determined differences.

The correction mapping may comprise a non-linear non-rigid projective correction transform matrix in some examples. The distortion of space as seen by the 3D scanner may be modelled as a non-linear non-rigid projective correction matrix operating on homogeneous coordinates, as exemplified by the relation below, which has 15 parameters with final (XYZ) coordinates to be divided by W:

$$[ \begin{matrix}{X}^{'} \\ {Y}^{'} \\ {Z}^{'} \\ W\end{matrix} ] = [ \begin{matrix}{h}_{1} & {h}_{2} & {h}_{3} & {h}_{4} \\ {h}_{5} & {h}_{6} & {h}_{7} & {h}_{8} \\ {h}_{9} & {h}_{10} & {h}_{11} & {h}_{12} \\ {h}_{13} & {h}_{14} & {h}_{15} & 1\end{matrix} ] [ \begin{matrix}X \\ Y \\ Z \\ 1\end{matrix} ]$$

The correction mapping may comprise a linear affine non-rigid correction transform matrix in some examples. A linear non-rigid affine correction transform, with 12 parameters, is simpler than the non-linear non-rigid projective correction matrix and is exemplified by the relation below:

$$[ \begin{matrix}{X}^{'} \\ {Y}^{'} \\ {Z}^{'} \\ W\end{matrix} ] = [ \begin{matrix}{a}_{1} & {a}_{2} & a & {a}_{4} \\ {a}_{5} & {a}_{6} & {a}_{7} & {a}_{8} \\ {a}_{9} & {a}_{10} & {a}_{11} & {a}_{12} \\ 0 & 0 & 0 & 1\end{matrix} ] [ \begin{matrix}X \\ Y \\ Z \\ 1\end{matrix} ]$$

Parameters of the correction transform matrix may be operated on by the non-linear optimisation. The objective function of the correction transform matrix in some examples is the sum of squared errors, wherein the errors are the determined differences between the known linear dimension and the linear dimension as obtained from the captured scan of the test object.

The projective transform may be used in examples for projective correction, because uncalibrated stereo systems that enforce the epi-polar geometry constraint through the calculation of the Fundamental matrix (e.g. by using eight or more determined correspondences between the two views) can reconstruct the world up to a projective correction, and unmodelled, or inaccurately modelled calibration parameters such as those of the test object may be similarly deficient. Tests using both types of corrections (projective and affine) indicate in some examples that an affine correction, which has the ability to scale and skew space, provides almost as good a correction transform as its non-linear counterpart.

After selecting a transformation to use, a next process is to compute the parameters of the correction matrix from the geometry data extracted from the scans of the multiple views of the measured test object. Individually, four points lying in or close to a plane may be insufficient information to approximate the affine or projective correction well. The affine transform requires four non-planar points, and the projective transform requires five. In some examples, the 12 or 15 parameters that describe the respective affine and projective correction transforms are made the subject of a non-linear optimisation, where the objective function is the sum of squared errors from the test object ensemble. In some examples with a test object as illustrated in FIGS. 3b, 3d-3e, using six length errors/differences L1 to L6, or using four Euclidean errors/differences obtained by comparing the position of each corner sphere centre with an expected position after transforming the position of the test object to the coordinate frame of the volume, for each position of the test object, work as well as each other in obtaining the non-linear transformation.

Mathematically, the following equation:

$$P = {arg min}_{P} {\sum }_{i}^{N} diff ( C ( {s}_{i} , P ) , M )$$

states that we wish to find the set of arguments (12 or 15 parameters of the correction matrix) P that minimize the sum over N scans of the test object is of the difference function diff between the corrected scan and the measured/known data M, where the application of the correction matrix is represented as the correction function C with parameters P. The function diff that expresses the difference between the scanned and previously measured/known measurements of the test object can be based either on the individual length differences between some or all of the individual spheres, or can be based on residual errors of the individual spheres after best alignment, as described above. In either case the individual errors (from each length measurement or each residual position error) can be combined as a sum of their squares to achieve a least squares result, in which case the function diff will return a square error.

The evaluation of the sum used as the error metric during the optimisation and expressed in the above equation can also be expressed as in the flow chart illustrated in FIG. 4, which shows an example evaluation of the error metric from the differences, according to example implementations. FIG. 4 shows that for each scan 402 (i.e. each 3D Scanned position of the test object), a correction is applied to the scan 404, a difference between the corrected scan dimension and the measured dimension is computed 406, and the differences for each scan is accumulated 408 (i.e. added to a total absolute difference or total squared difference). After each scan has been considered the process of accumulating the error metric for the current evaluation ends 410.

In some examples, determining the correction mapping may comprise using a neural network, such as a shallow neural network, to obtain the correction mapping based on the determined differences. A neural network may be used in regression mode to learn the mapping between data in one space and another based on training data. The error metric back propagated through the network may be based on the difference between the mapped and target data. In this case the neural network still learns the correction mapping, but the error itself to be back propagated through the network will be dependent on the accumulated linear dimension differences discussed above.

FIG. 5 shows an apparatus 500 according to example implementations. The apparatus 500 comprises: a processor 502; a computer readable storage 504 coupled to the processor 502; and an instruction set to cooperate with the processor 502 and the computer readable storage 504 to: receive, as input, a plurality of three-dimensional scans 506 of a test object having a known linear dimension at a respective plurality of positions within a volume, the scans captured by a three-dimensional imaging device; determine, based on the received input, a difference 508 between the known linear dimension and the linear dimension as obtained from the captured scan for each of the plurality of positions; and determine a correction mapping 510 for the volume based on the determined differences, the correction mapping indicating variation from an expected location of the location as captured by the imaging device. In some examples, the instruction set may be to cooperate with the processor 502 and the computer readable storage 504 to determine the correction mapping 510 by: performing a non-linear optimisation using the determined differences; or using a neural network based on the determined differences.

In some examples, the instruction set may be to cooperate with the processor 502 and the computer readable storage 504 to correct a three-dimensional scan of an object 512 captured using the three-dimensional imaging device, wherein the correction is based on the determined correction mapping. That is, the output of the 3D scanner/imaging device may be corrected by the apparatus 500 using the obtained correction mapping 510 to reduce or remove distortions in the captured 3D image 506 and provide a scan with improved accuracy compared with a non-corrected scan.

The processor 502 may comprise any suitable electronic processor (e.g., a microprocessor, a microcontroller, an application specific integrated circuit (ASIC), a field-programmable gate array (FPGA), etc.) that is configured to execute electronic instructions. The computer readable storage 504 may comprise any suitable memory device and may store a variety of data, information, instructions, or other data structures, and may have instructions for software, firmware, programs, algorithms, scripts, applications, etc. stored therein or thereon that may perform any method disclosed herein.

Also disclosed herein is a non-transitory computer readable storage medium 504 having executable instructions stored thereon which, when executed by a processor 502, cause the processor 502 to: obtain a linear dimension of a test object having a known linear dimension from a three-dimensional scan 506 of the test object located in a volume, the three-dimensional scan captured using a three-dimensional imaging device, at a plurality of positions within the volume; for each of the obtained linear dimensions, determine a difference 508 between the known linear dimension of a test object and the obtained linear dimension; and determine a correction mapping 510 for the volume based on the determined differences 508, the correction mapping 510 indicating variation from an expected location of the location as captured by the imaging device.

The computer readable medium 504 may comprise code to, when executed by a processor 502, cause the processor to perform any method described herein. The apparatus 500 in some examples may be, or may be comprised as part of, a 3D printing system. The apparatus 500 in some examples may be a suitable programmed computer, which may be in communication (wired or wireless) with a 3D printer, or in communication with the cloud or a remote server on which 3D scan data is stored, for example. The machine readable storage 504 may be realised using any type or volatile or non-volatile (non-transitory) storage such as, for example, memory, a ROM, RAM, EEPROM, optical storage and the like.

FIG. 6 illustrates an example of positioning a test object at a selection of each of a plurality of positions across the field of view of the 3D scanner for capture of a 3D scan of the object by the 3D scanner in those positions. In this example, a ball-plate test object as in FIGS. 3b, 3d-e is shown in seven different example positions of a total of 30 captured positions. There is shown a central position at (0, 0, 0) 604, and the test object has been rotated around its X (+15, —15, −60) and Y (+20, 0, −20) axes and translated in Z (+33, 0, −45) in various combinations. In each position in this example, spheres are robustly fitted to point-clouds within each scan 602 and the diameters and centres are recorded. Each sphere of the test object appears in the scan data as a portion of a sphere surface, representing the portion of each sphere's surface which can be seen/captured by the 3D scanner.

FIGS. 7a-7b show correction results from a test method according to example implementations. The plot of error type “before affine correction” in FIG. 7a and the plot of error type “after affine correction” in FIG. 7b each show the positional error in μm on the y-axis plotted against a combination of position and rotation parameters including Y-axis rotation (Ry) 702, Z-position (Pz) 704, and X-axis rotation (Rx) 706 on the x-axis for each of the four spheres of the test object, which was a test object as shown in FIGS. 3b and 3d-e, and shown in seven example positions in FIG. 6. The test object in this example was positioned in 30 positions in all, and 3D scans captured at each position.

The scan data of the test object and the “known”/well defined data of the defined length of the test object may be expressed as 4×3 matrices of the position centres of the four spheres of the ball-plate test object measurement. From the determined differences between the known linear dimension and the linear dimension as obtained from the each of the captured scans, the correction mapping may be determined for the volume. The correction mapping indicates variation from an expected location of the location as captured by the imaging device. The correction mapping may be obtained, for example, using a non-linear optimisation on the difference data as described above. That is, an effect of the minimization is to find an appropriate correction transform that reduces the errors in the 3D scans of the ball-plate at the different positions through the volume. An example of the performance of this approach can be seen in the results of FIG. 7b.

A striking feature of the results shown in FIG. 7b is that the larger individual errors of up to 27 μm 708, 710 (particularly for ball-plates with large rotations around X, which have the larger components in depth (Z) in the volume) shown in FIG. 7a, are reduced to less than 10 μm across the volume as shown in FIG. 7b. The results of FIG. 7b were obtained using an affine correction, but similar results were also observed using projective correction matrices, and in examples using a variety of 3D test objects.

In some examples the correction may be applied by using all the 3D scans (in this example, 30 scans each at a different position) to obtain the correction mapping for application to a further object scan. In some examples, a “leave one out” approach may be taken to test for overfitting, where one less than the total number of 3D scans (e.g. 29 of the 30 3D scans) are used to obtain the correction matrix which can then be applied to the 30th 3D scan to correct it. In other words, the 3D scan of the test object may be captured at a plurality of N positions; the non-linear optimisation may be performed using determined differences from each of the first to (N−1)th positions to obtain the correction mapping; and the obtained correction mapping determined from the non-linear optimisation may be applied to the linear dimension as obtained from the captured scan of the test object at the Nth position.

In the particular example of FIGS. 7a and 7b, while 30 3D scans in total were recorded and used to obtain the correction mapping, a similar correction mapping was obtained using 12 ball plate positions, rotated −60 and +45 around the X axis. In other examples, more or fewer than positions may be used. Using a more complex test object may allow the use of fewer scans to obtain a correction mapping for the full volume over which a correction may be desired.

Examples disclosed herein may provide the ability to create a volumetric correction matrix, which may be used to enhance the overall performance of a 3D scanner in the whole of its field of volume. Approaches described herein, using a well-characterised/known dimension of the test object as opposed to a well-characterised/known absolute position in space, may remove the need for an accurate metrology device, such as a CMM, to measure the position of the sphere or spheres held in position by e.g. a robot arm (and may remove the need for a precision positioning tool, such as a robot arm, for positioning of the test object at the well-known absolute positions). The test objects which may be used may be easy to make and it may be easy to measure the known dimensions; for example a planar ball-plate or a ball-bar may be used as a test object. Approaches disclosed herein may be applied in the field after calibration; that is, the 3D scan of an object may be recorded, and processed using a correction mapping as obtained here to correct the image. Approaches disclosed herein may also be used in the field between calibrations. Approaches disclosed herein may also readily be used with existing 3D scanning technology of various types without using specialist scanning apparatus, nor a specialist precision positioning tool for positioning a test object for calibration.

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the contest suggests otherwise. In particular, where the indefinite article is used, the specification is to be understood as contemplating plurality as well as singularity, unless the contest suggests otherwise.

The following numbered paragraphs also form part of this disclosure:
1. There is disclosed herein a computer-implemented method comprising: locating a test object having a known linear dimension at a plurality of positions within a volume; at each of the plurality of positions, capturing a three-dimensional scan of the test object using a three-dimensional imaging device; and determining a difference between the known linear dimension and the linear dimension as obtained from the captured scan; and determining a correction mapping for the volume based on the determined differences, the correction mapping indicating variation from an expected location of the location as captured by the imaging device.
2. The method according to paragraph 1, wherein determining the difference comprises: extracting, from the three-dimensional scan, a scan dimension corresponding to the known linear dimension of the test object; and determining a difference between the extracted scan dimension and the known linear dimension of the test object.
3. The method according to paragraph 1 or paragraph 2, wherein determining the difference comprises: aligning the three-dimensional scan of the test object with a predetermined position of the known test object in a coordinate frame of the volume; and determining differences between respective end point positions of the linear dimension of the aligned scanned test object, and the corresponding respective end point positions of the linear dimension of the known test object.
4. The method according to any of paragraphs 1 to 3, wherein determining the correction mapping comprises performing a non-linear optimisation using the determined differences to obtain the correction mapping.
5. The method according to any of paragraphs 1 to 4, wherein the correction mapping comprises: a non-linear non-rigid projective correction transform matrix; or a linear affine non-rigid correction transform matrix.
6. The method according to any of paragraphs 1 to 5, wherein parameters of the correction transform matrix are operated on by the non-linear optimisation, and wherein the objective function of the correction transform matrix is the sum of squared errors, wherein the errors are the determined differences between the known linear dimension and the linear dimension as obtained from the captured scan of the test object.
7. The method according to any of paragraphs 1 to 3, wherein determining the correction mapping comprises using a neural network to obtain the correction mapping based on the determined differences.
8. The method according to any of paragraphs 1 to 7, comprising: correcting a three-dimensional scan of an object captured using the three-dimensional imaging device, wherein the correction is based on the determined correction mapping.
9. The method according to any of paragraphs 1 to 8, wherein locating the test object at the plurality of positions comprises one or more of translation, and rotation, of the test object in the volume.
10. The method according to any of paragraphs 1 to 9, wherein the test object is: a straight bar with a sphere located at each end of the bar, wherein the known linear dimension is the distance between the centres of the spheres; a planar structure providing a plurality of mounting points, with a plurality of spheres each located at respective mounting points, wherein the known linear dimension is a distance between the centres of two spheres; or a non-planar structure comprising a plurality of structures oriented out of a plane.
11. The method according to any of paragraphs 1 to 10, wherein the test object is made of a material having thermal expansion properties providing for dimensional variations of the test object due to thermal changes to be lower than the accuracy with which the linear dimension of the test object can be determined from the three-dimensional scans.
12. Disclosed herein is an apparatus comprising: a processor; a computer readable storage coupled to the processor; and an instruction set to cooperate with the processor and the computer readable storage to: receive, as input, a plurality of three-dimensional scans of a test object having a known linear dimension at a respective plurality of positions within a volume, the scans captured by a three-dimensional imaging device; determine, based on the received input, a difference between the known linear dimension and the linear dimension as obtained from the captured scan for each of the plurality of positions; and determine a correction mapping for the volume based on the determined differences, the correction mapping indicating variation from an expected location of the location as captured by the imaging device.
13. The apparatus of paragraph 12, wherein the instruction set is to cooperate with the processor and the computer readable storage to: correct a three-dimensional scan of an object captured using the three-dimensional imaging device, wherein the correction is based on the determined correction mapping.
14. The apparatus of paragraph 12 or paragraph 13, wherein the instruction set is to cooperate with the processor and the computer readable storage to determine the correction mapping by: performing a non-linear optimisation using the determined differences; or using a neural network based on the determined differences.

1. A computer-implemented method comprising:
locating a test object having a known linear dimension at a plurality of positions within a volume;
at each of the plurality of positions, capturing a three-dimensional scan of the test object using a three-dimensional imaging device; and determining a difference between the known linear dimension and the linear dimension as obtained from the captured scan; and
determining a correction mapping for the volume based on the determined differences, the correction mapping indicating variation from an expected location of the location as captured by the imaging device.

2. The method according to claim 1, wherein determining the difference comprises:
extracting, from the three-dimensional scan, a scan dimension corresponding to the known linear dimension of the test object; and
determining a difference between the extracted scan dimension and the known linear dimension of the test object.

3. The method according to claim 1, wherein determining the difference comprises:
aligning the three-dimensional scan of the test object with a predetermined position of the known test object in a coordinate frame of the volume; and
determining differences between respective end point positions of the linear dimension of the aligned scanned test object, and the corresponding respective end point positions of the linear dimension of the known test object.

4. The method according to claim 1, wherein determining the correction mapping comprises performing a non-linear optimisation using the determined differences to obtain the correction mapping.

5. The method according to claim 4, wherein the correction mapping comprises:
a non-linear non-rigid projective correction transform matrix; or
a linear affine non-rigid correction transform matrix.

6. The method according to claim 5, wherein parameters of the correction transform matrix are operated on by the non-linear optimisation, and wherein the objective function of the correction transform matrix is the sum of squared errors, wherein the errors are the determined differences between the known linear dimension and the linear dimension as obtained from the captured scan of the test object.

7. The method according to claim 1, wherein determining the correction mapping comprises using a neural network to obtain the correction mapping based on the determined differences.

8. The method according to claim 1, comprising:
correcting a three-dimensional scan of an object captured using the three-dimensional imaging device, wherein the correction is based on the determined correction mapping.

9. The method according to claim 1, wherein locating the test object at the plurality of positions comprises one or more of translation, and rotation, of the test object in the volume.

10. The method according to claim 1, wherein the test object is:
a straight bar with a sphere located at each end of the bar, wherein the known linear dimension is the distance between the centres of the spheres;
a planar structure providing a plurality of mounting points, with a plurality of spheres each located at respective mounting points, wherein the known linear dimension is a distance between the centres of two spheres; or
a non-planar structure comprising a plurality of structures oriented out of a plane.

11. The method according to claim 1, wherein the test object is made of a material having thermal expansion properties providing for dimensional variations of the test object due to thermal changes to be lower than the accuracy with which the linear dimension of the test object can be determined from the three-dimensional scans.

12. An apparatus comprising:
a processor;
a computer readable storage coupled to the processor; and
an instruction set to cooperate with the processor and the computer readable storage to:
receive, as input, a plurality of three-dimensional scans of a test object having a known linear dimension at a respective plurality of positions within a volume, the scans captured by a three-dimensional imaging device;
determine, based on the received input, a difference between the known linear dimension and the linear dimension as obtained from the captured scan for each of the plurality of positions; and
determine a correction mapping for the volume based on the determined differences, the correction mapping indicating variation from an expected location of the location as captured by the imaging device.

13. The apparatus of claim 12, wherein the instruction set is to cooperate with the processor and the computer readable storage to:
correct a three-dimensional scan of an object captured using the three-dimensional imaging device, wherein the correction is based on the determined correction mapping.

14. The apparatus of claim 12, wherein the instruction set is to cooperate with the processor and the computer readable storage to determine the correction mapping by:
performing a non-linear optimisation using the determined differences; or
using a neural network based on the determined differences.

15. A non-transitory computer readable storage medium having executable instructions stored thereon which, when executed by a processor, cause the processor to:
obtain a linear dimension of a test object having a known linear dimension from a three-dimensional scan of the test object located in a volume, the three-dimensional scan captured using a three-dimensional imaging device, at a plurality of positions within the volume;
for each of the obtained linear dimensions, determine a difference between the known linear dimension of a test object and the obtained linear dimension; and
determine a correction mapping for the volume based on the determined differences, the correction mapping indicating variation from an expected location of the location as captured by the imaging device.
